(19) United States
(12) Patent Application Publication
(10) Pub. No.: US 2022/0076552 A1
(43) Pub. Date: Mar. 10, 2022

(54) SMART FIRE DETECTOR

(71) Applicant: TELCOKOREA IS, Inc., Daejeon (KR)

(72) Inventor: Jung Jip KIM, Daejeon (KR)

(73) Assignee: TELCOKOREA IS, Inc., Daejeon (KR)

(21) Appl. No.: 17/399,834

(22) Filed: Aug. 11, 2021

(30) Foreign Application Priority Data
Sep. 8, 2020 (KR) 10-2020-0114569

(51) Int. Cl. G08B 17/12; G08B 7/06; G06K 9/62; G06K 9/00

(52) U.S. Cl. CPC G08B 17/125; G06K 9/00771; G06K 9/6201; G08B 7/066

(57) ABSTRACT

A smart fire detector according to the present invention includes a sensing unit configured to detect one or more fire elements, a controller configured to analyze sensing signals detected by the sensing unit to determine whether a fire has occurred and to output a fire signal upon determining one or more of the fire elements to be a fire, an imaging unit configured to take an image of an area in which the fire elements have been detected according to the fire signal and to extract an image and a picture of a high-definition snapshot from the taken image, and a notification unit configured to output a fire alarm and near fire escape route guidance sound according to the fire signal. Accordingly, the present invention can notify not only of a fire but also of a detected fire element for each type through analysis of a detected fire element.

### BACKGROUND OF THE INVENTION

### Field of the Invention

The present invention relates to a smart fire detector capable of notifying not only of a fire but also of a detected fire element for each type.

### Description of the Related Art

In general, a fire detector is a device that is provided on a ceiling in a building at regular intervals, detects a temperature, smoke, and the like in case of fire, and transmits a fire detection signal to a receiver electrically connected thereto to generate a fire alarm sound.

That is, a fire detector is a device that detects heat, smoke, flame, and the like generated in case of fire and generates a fire alarm for the purpose of preventing a fire which unexpectedly occurs in buildings for business and residence.

Korean Patent No. 1816769 (registered on Jan. 1, 2018) (hereinafter referred to as prior art document) relates to a fire detector configured by combining an IP camera and a flame detector. In the prior art document, when a tall obstacle that hinders detection of a flame sensor is in front of the IP camera providing images of a fire in real time when the fire is detected, a warning is generated such that a manager moves the obstacle to achieve smooth fire detection.

However, in the prior art document, when a power outage occurs in case of fire, the fire detector does not have a system for preparing for a power outage. In addition, a fire cannot be detected if the Internet is disconnected due to a power outage. Furthermore, a malfunction may occur because cigarette smoke or the like is hardly discriminated from smoke caused by a fire.

Accordingly, there is need for development of a fire detector capable of detecting a fire and a detected fire element for each type while having a system for preparing for a power outage.

### SUMMARY OF THE INVENTION

Therefore, the present invention has been made in view of the above problems, and it is an object of the present invention to provide a smart fire detector capable of notifying not only of a fire but also of a detected fire element for each type through analysis of a detected fire element for each type.

It will be appreciated by persons skilled in the art that the object that could be achieved with the present invention is not limited to what has been particularly described hereinabove and the above and other objects that the present invention could achieve will be more clearly understood from the following detailed description.

In accordance with an aspect of the present invention, the above and other objects can be accomplished by the provision of a smart fire detector including a sensing unit configured to detect one or more fire elements, a controller configured to analyze sensing signals detected by the sensing unit to determine whether a fire has occurred and to output a fire signal upon determining one or more of the fire elements to be relevant to a fire occurrence, an imaging unit configured to take an image of an area in which the fire elements have been detected according to the fire signal and to extract an image and a picture of a high-definition snapshot from the taken image, and a notification unit configured to output a fire alarm and near fire escape guidance sound according to the fire signal, wherein the fire elements include heat, smoke, gases, and particulate matter, and the controller includes a communication unit configured to transmit the image and the picture of the high-definition snapshot extracted through the imaging unit to a control center, and a determination unit configured to compare measurement values of the fire elements detected by the sensing unit with preset reference values and analyze comparison results, wherein the determination unit determines that a fire has occurred if the measurement values of the fire elements exceed the preset reference values.

The smart fire detector may include a plurality of the sensing units, and a plurality of interface units connected to the plurality of the sensing units and configured to transmit sensing signals of the plurality of the sensing units to the controller, and the plurality of the interface units may be disposed in different directions such that the plurality of the sensing units connected to the plurality of the interface units are disposed in different directions.

The controller may drive the imaging unit such that the imaging unit faces a sensing unit outputting a sensing signal corresponding to the fire signal among the plurality of the sensing units and takes an image of the area in which the fire elements have been detected.

The controller may derive recognition parameters of a flame image by processing images and pictures of snapshots taken in the past through machine learning, and applies the recognition parameters to the image of the area in which the fire elements are detected.

The smart fire detector may include a power unit for operation of the sensing unit, the controller, the imaging unit, and the notification unit, and the power unit may include a main power for normally supplying power and an auxiliary power for supplying power in case of fire, and power may be supplied from the auxiliary power before the main power is cut off when the controller outputs the fire signal.

Power may be supplied from the main power until the main power is cut off when the auxiliary power is not able to normally supply power.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram schematically illustrating a smart fire detector according to an embodiment of the present invention;

FIG. 2 is a flowchart illustrating a fire detection method using the smart fire detector of the present invention;

FIG. 3 is a flowchart illustrating a non-smoking area notification method using the smart fire detector of the present invention;

FIG. 4 is a flowchart illustrating a particulate matter notification method using the smart fire detector of the present invention;

FIG. 5 is a plan view of the smart fire detector according to an embodiment of the present invention; and

FIG. 6 is an internal structure of the smart fire detector viewed from the side.

### DETAILED DESCRIPTION OF THE INVENTION

Reference will now be made in detail to the preferred embodiments of the present invention, examples of which are illustrated in the accompanying drawings. While the invention will be described with reference to the accompanying drawings, it will be appreciated by persons skilled in the art that the accompanying drawings are merely used to facilitate disclosure of the present description and the scope of the present invention is not limited to the drawings.

Further, the terms used in the specification of the present invention are merely used in order to describe particular embodiments, and are not intended to limit the scope of the present invention. An element described in the singular form is intended to include a plurality of elements unless the context clearly indicates otherwise.

In the specification of the present invention, it will be further understood that the term “comprise” or “include” specifies the presence of stated features, integers, steps, operations, elements, components, and/or combinations thereof, but do not preclude the presence or addition of one or more other features, integers, steps, operations, elements, components, and/or combinations thereof.

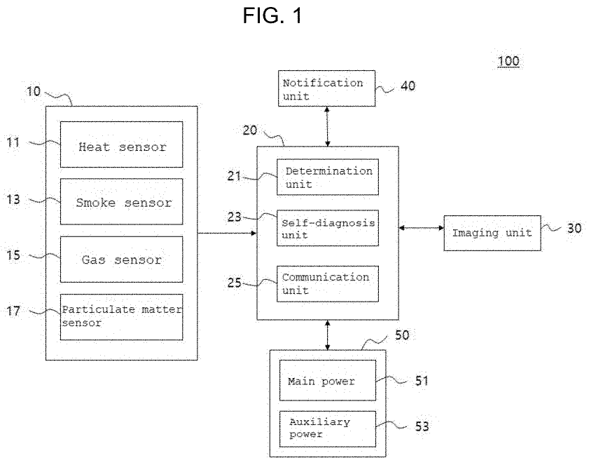

FIG. 1 is a block diagram schematically illustrating a smart fire detector according to an embodiment of the present invention.

Referring to FIG. 1, the smart fire detector 100 includes a sensing unit 10, a controller 20, an imaging unit 30, a notification unit 40, and a power unit 50.

The sensing unit 10 detects one or more fire elements.

The controller 20 analyzes sensing signals detected by the sensing unit 10 to determine whether a fire has occurred and outputs a fire signal upon determining one of more fire elements to be relevant to a fire occurrence.

The imaging unit 30 takes images of an area in which the fire elements are detected according to a fire signal and extracts images and pictures of high-definition snapshots from the taken images.

The notification unit 40 outputs a fire warning and near fire escape route guidance sound according to the fire signal.

Herein, the fire elements include at least one of heat, smoke, gas, and particulate matter.

The controller 20 may further include a communication unit 25 and a determination unit 21.

The communication unit 25 is used to transmit the images and pictures of high-definition snapshots extracted through the imaging unit 30 to a control center.

The determination unit 21 compares measurement values of the fire elements detected by the sensing unit 10 with predetermined reference values and analyzes comparison results. If the measurement values of the fire elements exceed the predetermined reference values, the determination unit 21 determines that a fire has occurred.

The sensing unit 10 capable of detecting fire elements may include a heat sensor 11, a smoke sensor 13, a gas sensor 15, and a particulate matter sensor 17.

The heat sensor 11 is a sensor for measuring heat (temperature) and may detect heat (temperature) through a constant temperature method using a thermistor. Further, the heat sensor 11 may detect heat (temperature) through a differential temperature method in which a thermal time constant of one of two combined temperature sensors is set to be large, a thermal time constant of the other is set to be small, and a temperature increase rate is detected from a difference between temperatures detected thereby. In addition, the heat sensor 11 may detect the heat of the human body to detect biological change.

The smoke sensor 13 may detect smoke concentration through a photoelectric method. The smoke sensor 13 may increase or decrease sensitivity to smoke concentration. The gas sensor 15 may detect gas concentration of organic matter generated according to heating through an electrochemical method. Here, the organic matter generated according to heating may be any one of carbon monoxide, carbon dioxide, hydrogen chloride, BHT gas, chlorine, and ethylene.

The particulate matter sensor 17 may detect an atmospheric condition of a measurement area through a light scattering method. Here, the light scattering method is a method of measuring the quantity of scattering light using the principle that light scatters in various directions when light is shined at an object and obtaining particulate matter concentration from the measured value. Here, particulate matter may include dust, pollen, smoke generated when fossil fuel is burnt, methane generated when an organic matter is burnt, alcohol, carbon compounds such as benzene and phenol, nitrogen oxide, and sulfur oxide. Particulate matter (PM) is classified into PM 10, PM 2.5, and PM 1.0 according to particle size. PM 10 has a particle size of 10 μm or less, PM 2.5 has a particle size of 2.5 μm or less, and PM 1.0 has a particle size of 1.0 μm or less. Such particulate matter may cause diseases such as heart disease and lung cancer when deposited in the human lung.

The controller 20 may determine whether a fire has occurred, notify of the fire, and control communication with the outside through components of the fire detector 100.

The controller 20 may include a determination unit 21, a self-diagnosis unit 23, and a communication unit 25.

The determination unit 21 may determine whether a fire has occurred by analyzing sensing signals output from sensors constituting the sensing unit 10. That is, the determination unit 21 may output a fire signal upon determining one or more fire elements to be relevant to a fire occurrence.

The determination unit 21 may determine whether a fire has occurred by comparing a measurement value of heat (temperature) detected by the heat sensor 11 with a predetermined outdoor temperature reference value in case of fire and analyzing a comparison result.

The determination unit 21 analyzes smoke detected by the smoke sensor 13 for each type and determines whether a fire has occurred. Here, smoke types may be classified into cigarette smoke, inflammable gas, poisonous gas smoke, smoke caused by fire, etc.

The determination unit 21 may determine whether a fire has occurred by comparing a smoke concentration measurement value detected by the smoke sensor 13 with a reference value preset on the basis of a concentration difference for each smoke type and analyzing a comparison result.

The determination unit 21 may determine whether a fire has occurred by comparing a gas concentration measurement value detected by the gas sensor 15 with a preset gas concentration reference value and analyzing a comparison result.

The determination unit 21 may determine an atmospheric condition by comparing particulate matter concentration detected by the particulate matter sensor 17 with a particulate matter threshold value and analyzing a comparison result. The determination unit 21 may control the notification unit 40 to notify of information on the determined atmospheric condition.

Particulate matter threshold values are shown in Table 1.

TABLE 1

| Particulate matter concentration | Condition |
|---|---|
| 35 to 75 μm | Bad |
| 76 to 149 μm | Very bad |
| 150 μm or more | Worst, alarm |
| Fire determination reference value | Occurrence of fire |

Accordingly, the determination unit 21 may generate a fire signal and control notification of a fire alarm and a fire escape route through the notification unit 40 upon determining that a fire has occurred through analysis of detected heat, smoke, gas and particulate matter. Here, the determination unit 21 may control images and pictures of high-definition snapshots extracted through the imaging unit 30 to be transmitted to a control center (not illustrated). Accordingly, it is possible to transmit images and pictures about a fire to the control center (not illustrated) simultaneously with occurrence of the fire to rapidly take measures against the fire.

The self-diagnosis unit 23 may check an operation state of the sensing unit 10 in real time to diagnose an abnormal operation of the sensing unit 10. The self-diagnosis unit 23 may diagnose operation states such as a power supply state and insufficient battery capacity. In addition, the self-diagnosis unit 23 may transmit self-diagnosis information to the control center (not illustrated) through the communication unit 25.

Accordingly, it is possible to simplify fire inspection without using manpower.

The communication unit 25 may perform communication with the outside according to control of the controller 20. The communication unit 25 may use a 1 GHz band wireless network. Here, a network may refer to a network through which data can be transmitted and received using an Internet protocol through various wired/wireless communication technologies, such as the Internet, an intranet, a mobile communication network, and a satellite communication network. Further, networks based on Code Division Multiple Access (CDMA), Wideband Code Division Multiple Access (WCDMA), Global System for Mobile Communication (GSM), Long Term Evolution (LTE), Evolved Packet Core (EPC), Wireless Fidelity (Wi-Fi), wireless Lan (WLAN), next-generation networks which will be implemented in the future, and computing networks as well as closed networks such as a local area network (LAN) and a wide area network (WAN), and an open network such as the Internet may be commonly called a network.

The imaging unit 30 may include a camera for taking images of areas in which sensors constituting the sensing unit 10 are installed. The imaging unit 30 may include a camera which can turn 180 degrees to take images. In addition, the imaging unit 30 may take an image of an area in which fire elements have been detected according to a fire signal generated under the control of the controller 20. The imaging unit 30 may extract an image and a picture of a high-definition snapshot from the taken image.

The imaging unit 30 may transmit the extracted image and picture to the control center (not illustrated) under the control of the controller 20. Accordingly, the present invention can reduce a time taken to arrive at the scene of a fire to check a fire situation and to confirm occurrence of fire through an image and a picture of a high-definition snapshot immediately after occurrence of fire to take rapid measures.

The notification unit 40 may include a speaker. The notification unit 40 may output a warning sound with respect to a fire, a smoking alarm in a non-smoking area, and an atmospheric condition including particulate matter, etc. according to a fire signal generated under the control of the controller 20. Further, the notification unit 40 may output a guidance sound with respect to a near fire escape route in case of fire. Here, the warning sound and the fire escape guidance sound may be recorded through an audio chip and then output.

It is possible to immediately deliver a fire occurrence situation to a place in which a fire has occurred such that people cope with or escape from the fire by generating a fire alarm under the control of the controller 20 to allow prompt action.

The power unit 50 may include a main power 51 using a wired power supply and an auxiliary power 53 using a battery.

The power unit 50 may supply power through the main power 51 for operation of the fire detector 100 and may supply emergency power through the auxiliary power 53 when power supply from the main power 51 is cut off due to fire. Accordingly, a power outage preparation system can be constructed.

Meanwhile, the lifespan of a battery depends on humidity conditions or temperature conditions of the surrounding environment. When the lifespan of the battery is nearing an end, power from the battery is not smoothly supplied and thus the battery cannot normally operate in case of emergency and a fire may not be detected. Accordingly, the battery may be charged or replaced according to diagnosis of the self-diagnosis unit 23.

As described above, the present invention can notify not only of a fire but also of a detected fire element for each type through analysis of a detected fire element for each type to secure reliability of fire supervision and warning.

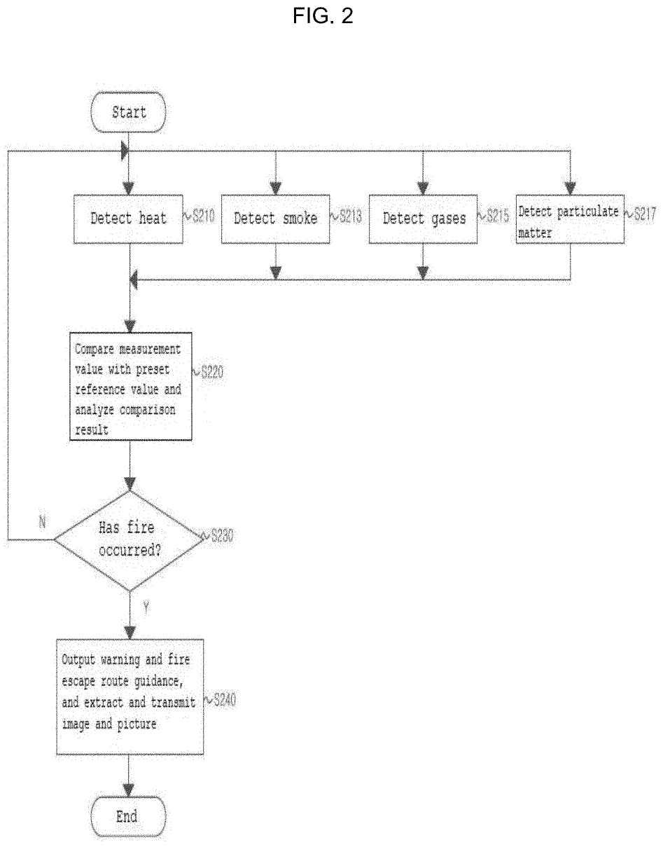

FIG. 2 is a flowchart illustrating a fire detection method using the smart fire detector of the present invention.

Referring to FIG. 1 and FIG. 2, the controller 20 may determine whether a fire has occurred by respectively comparing measurement values of sensing signals detected by the sensing unit 10 with preset reference values and analyzing comparison results. That is, when at least one of the measurement values exceeds a corresponding reference value, the controller 20 may determine that a fire has occurred. Here, the preset reference values may be set by a manager for temperature, smoke, gas, and particulate matter.

First, the heat sensor 11 of the sensing unit 10 detects heat (temperature) in an fire detection area and the sensing unit 10 outputs a measurement value of the detected heat (temperature) to the controller 20 (S210). The controller 20 compares the measurement value of the detected heat with a preset outdoor heat (temperature) reference value and analyzes a comparison result through the determination unit 21 (S220). If the measurement value of the detected heat exceeds the preset outdoor heat (temperature) reference value as a comparative analysis result, it is determined that a fire has occurred (S230: Y). If the measurement value of the detected heat does not exceed the preset outdoor heat (temperature) reference value (S230: N) as a comparative analysis result, step S210 is repeated.

The smoke sensor 13 of the sensing unit 10 detects smoke in the fire detection area and the sensing unit 10 outputs a measurement value of the concentration of the detected smoke to the controller 20 (S213). The controller 20 compares the measurement value of the detected smoke concentration with a reference value preset on the basis of a concentration difference for each smoke type and analyzes a comparison result through the determination unit 21 (S220). If the measurement value of the detected smoke concentration exceeds the preset reference value (S230: Y) as a comparative analysis result, it is determined that a fire has occurred. If the measurement value of the detected smoke concentration does not exceed the preset reference value (S230: N) as a comparative analysis result, step S213 is repeated.

The gas sensor 15 of the sensing unit 10 detects gases in the fire detection area and the sensing unit 10 outputs a measurement value of the concentration of the detected gases to the controller 20 (S215). The controller 20 compares the measurement value of the detected gas concentration with a preset gas concentration reference value and analyzes a comparison result through the determination unit 21 (S220). If the measurement value of the detected gas concentration exceeds the preset reference value as a comparative analysis result (230: Y), it is determined that a fire has occurred. If the measurement value of the detected gas concentration does not exceed the preset reference value (S230: N) as a comparative analysis result, step S215 is repeated.

The particulate matter sensor 17 of the sensing unit 10 detects an atmospheric condition of the fire detection area and the sensing unit 10 outputs a measurement value of detected particulate matter to the controller 20 (S217). The controller 20 compares the measurement value of the detected particulate matter with a preset fire determination reference value and analyzes a comparison result through the determination unit 21 (S220). If the measurement value of the detected particulate matter exceeds the preset fire determination reference value (S230: Y) as a comparative analysis result, it is determined that a fire has occurred. If the measurement value of the detected particulate matter does not exceed the preset fire determination reference value (S230: N) as a comparative analysis result, step S217 is repeated.

When the controller 20 determines that a fire caused by one or more fire elements has occurred, the determination unit 21 generates a fire signal and the notification unit 40 outputs a fire alarm and near fire escape route guidance sound. Simultaneously, the controller 20 transmits an image and a picture of a high-definition snapshot extracted through the imaging unit 30 to the control center (not illustrated) (S240).

Accordingly, the present invention can cope with a fire such that people can rapidly escape in case of fire. Furthermore, it is possible to rapidly analyze a fire situation by transmitting an image and a picture of an area in which a fire has occurred to the control center.

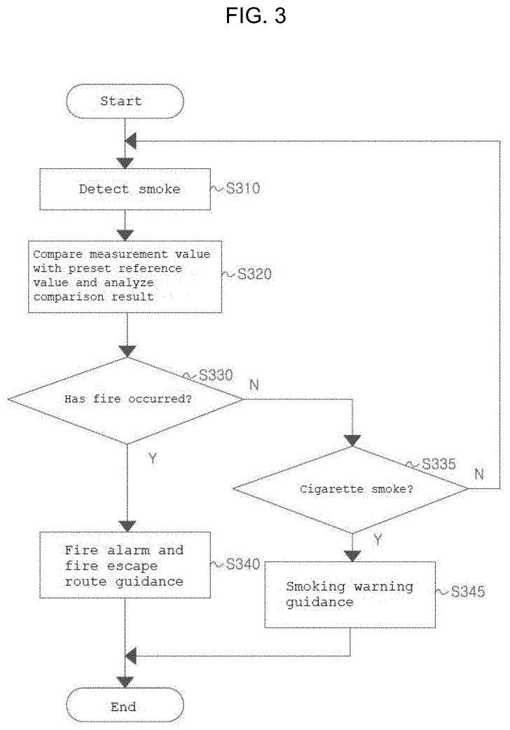

FIG. 3 is a flowchart illustrating a non-smoking area notification method using the smart fire detector of the present invention.

Referring to FIG. 1 and FIG. 3, the smoke sensor 13 of the sensing unit 10 detects smoke in an fire detection area and the sensing unit 10 outputs a measurement value of the concentration of the detected smoke to the controller 20 (S310).

The controller 20 compares the measurement value of the detected smoke concentration with a reference value preset on the basis of a concentration difference for each smoke type and analyzes a comparison result through the determination unit 21 (S320).

If the measurement value of the detected smoke concentration exceeds the preset reference value (S330: Y) as a comparative analysis result, it is determined that a fire has occurred. Upon determining that a fire has occurred, the determination unit 21 generates a fire signal and the notification unit 40 outputs a fire alarm and near fire escape route guidance sound. Simultaneously, the determination unit 21 transmits an image and a picture of a high-definition snapshot extracted through the imaging unit 30 to the control center (not illustrated) (S340).

If the measurement value of the detected smoke concentration does not exceed the preset reference value (S330: N) and corresponds to cigarette smoke among smoke types (S335: Y) as a comparative analysis result, the determination unit 21 determines the detected smoke to be cigarette smoke.

If the measurement value of the detected smoke concentration does not correspond to cigarette smoke among the smoke types (S335: N) as a comparative analysis result, step S310 is repeated.

Upon determining that the measurement value of the detected smoke concentration corresponds to cigarette smoke (S335: Y), a smoking warning sound is output through the notification unit 40 (S345).

Therefore, according to the present invention, it is possible to supervise smoking in a non-smoking area without an additional CCTV.

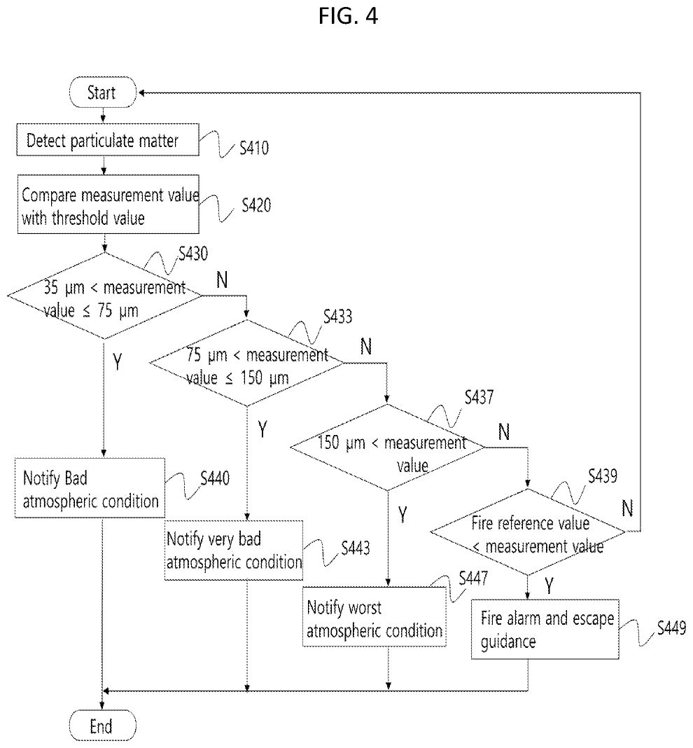

FIG. 4 is a flowchart illustrating a particulate matter notification method using the smart fire detector of the present invention.

Referring to FIG. 1 and FIG. 4, the particulate matter sensor 17 of the sensing unit 10 detects an atmospheric condition of an fire detection area and generates a measurement value of detected particulate matter. The sensing unit 10 outputs the measurement value of detected particulate matter to the controller 20 (S410).

The controller 20 compares the measurement value of the detected particulate matter with a preset particulate matter threshold value through the determination unit 21 (S420).

If the measurement value of the detected particulate matter exceeds a preset particulate matter concentration of 35 μm and is less than 75 μm (S430: Y) as a comparative analysis result, a guidance sound representing a bad atmospheric condition is output through the notification unit 40 (S440).

If the measurement value of the detected particulate matter exceeds the preset particulate matter concentration of 75 μm (S430: N) and is less than 150 μm (S433: Y) as a comparative analysis result, a guidance sound representing a very bad atmospheric condition is output through the notification unit 40 (S443).

If the measurement value of the detected particulate matter exceeds a preset particulate matter concentration of 150 μm (S433: N) and is less than a preset fire determination reference value (S437: Y) as a comparative analysis result, a guidance sound representing a worst atmospheric condition is output through the notification unit 40 (S447).

If the measurement value of the detected particulate matter exceeds the preset fire determination reference value (S439: Y) as a comparative analysis result, it is determined that a fire has occurred. If the measurement value of the detected particulate matter does not exceed the preset fire determination reference value (S439: N) as a comparative analysis result, step S410 is repeated. Upon determining that a fire has occurred, the determination unit 21 generates a fire signal and outputs a fire alarm and near fire escape route guidance sound through the notification unit 40. Simultaneously, the determination unit 21 transmits an image and a picture of a high-definition snapshot extracted through the imaging unit 30 to the control center (not illustrated) (S449).

Accordingly, it is possible to check an atmospheric condition of a measurement area at any time without an additional particulate matter meter according to the present invention. Therefore, the fire detector can be used normally as well as in case of fire. Consequently, the efficiency of the fire detector is improved.

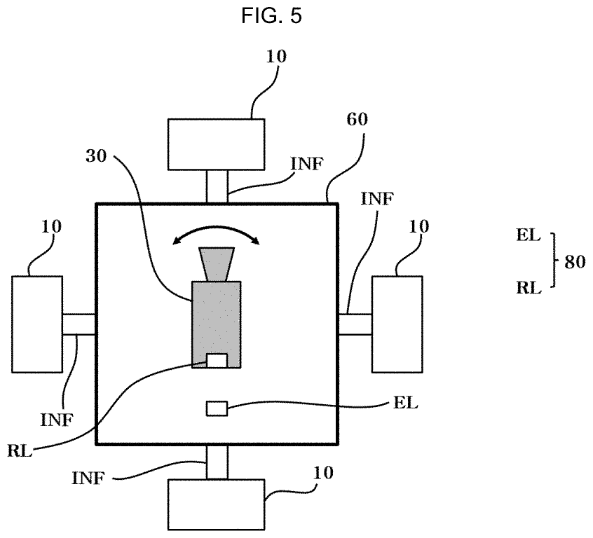

As illustrated in FIG. 5, the smart fire detector 100 according to an embodiment of the present invention may include a plurality of sensing units 10 and a plurality of interface units INF.

The plurality of interface units INF may be connected to the plurality of sensing units 10 and may transmit sensing signals of the plurality of sensing units 10 to the controller 20. The plurality of interface units INF may support serial transmission or parallel transmission of sensing signals. For example, the interface units INF may be USB or RS-232C, but the present invention is not limited thereto.

Here, the plurality of interface units INF may be disposed in different directions such that the plurality of sensing units 10 connected to the plurality of interface units INF may be disposed in different directions.

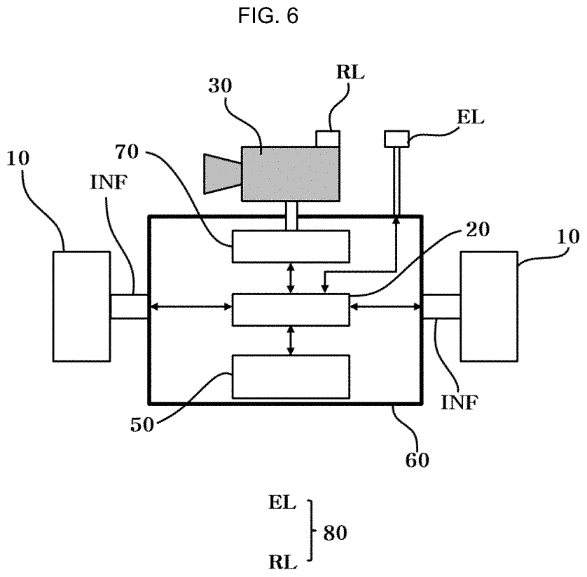

FIG. 5 is a plan view of the smart fire detector 100 according to an embodiment of the present invention and FIG. 6 is an internal structure of the smart fire detector 100 viewed from the side. In the internal structure of FIG. 6, some components are omitted for convenience of description.

For example, as illustrated in FIG. 5 and FIG. 6, a plurality of interface units INF may be provided at intervals of 90 degrees in a body 60 on the basis of the center of the body 60. In addition, a single sensing unit may be connected to each interface unit INF. Accordingly, each sensing unit 10 of the smart fire detector 100 can detect fire elements of an area corresponding thereto.

The number and alignment angle of the interface units INF in FIG. 5 and FIG. 6 are merely an example and the present invention is not limited thereto.

Here, the controller 20 may drive the imaging unit 30 such that the imaging unit 30 faces a sensing unit 10 that outputs a sensing signal corresponding to a fire signal among the plurality of sensing units 10 and takes an image of an fire detection area in which a fire element has been detected.

To this end, a driver 70 for rotating the imaging unit 30 may be included in the body 60, and the driver 70 may include a motor connected to the imaging unit 30 through the central axis thereof. The operation of the driver 70 may be controlled by the controller 20.

As described above, the imaging unit 30 takes an image of an fire detection area in which a fire element has been detected according to a fire signal. Here, a sensing signal corresponding to a fire signal may be transmitted from a sensing unit 10 connected to a front interface unit INF among the plurality of interface units INF, as illustrated in FIG. 5.

In this case, the controller 20 may control the driver 70 such that the imaging unit 30 faces a front area and takes an image of the front area.

Since an imaging area of the imaging unit 30 may change, a rotation angle of the imaging unit 30 needs to be controlled and thus a reference position may need to be set. To this end, the smart fire detector 100 according to an embodiment of the present invention may include a reference position setting unit 80.

The reference position setting unit 80 may transmit a signal with respect to a reference position of the imaging unit 30 to the controller 20. The controller 20 may control the rotation angle of the imaging unit 30 according to the signal with respect to the reference position.

For example, as illustrated in FIG. 5 and FIG. 6, the reference position setting unit 80 may include a light emitter EL and a light receiver RL. Here, one of the light emitter EL and the light receiver RL may be included in the imaging unit 30, and the other may be included in the body 60.

When the light emitter EL and the light receiver RL are aligned in a straight line, light emitted from the light emitter EL is incident on the light receiver RL, and thus the light receiver RL can transmit a signal with respect to a reference position to the controller 20. The controller 20 may determine that the imaging unit 30 is at the reference position (front in FIG. 5).

If the controller 20 receives a sensing signal corresponding to a fire signal from a left sensing unit 10, the controller 20 may control the driver 70 such that the imaging unit 30 rotates counterclockwise by 90 degrees.

In addition, the controller 20 may store information representing that the position of the imaging unit 30 has rotated counterclockwise by 90 degrees in a memory (not illustrated).

Accordingly, the imaging unit 30 may take an image of a left area in which a fire has occurred.

Further, the controller 20 may analyze an image of an fire detection area in which a fire element has been detected through recognition parameters of flame images derived through machine learning from images and pictures of snapshots taken in the past. Accordingly, the controller 20 can determine occurrence of fire relatively accurately even though a person does not view images taken by the imaging unit 30.

Further, a power unit 50 may include a main power 51 that normally supplies power and an auxiliary power 53 that supplies power in case of fire. When the controller 20 outputs a fire signal, power may be supplied from the auxiliary power 53 before the main power 51 is cut off due to fire.

In the case of the above-described power unit 50, the auxiliary power 53 may supply power after the main power is cut off due to fire. In contrast, the auxiliary power 53 and the main power 51 may be differently operated.

That is, when a fire signal according to fire is generated, the smart fire detector 100 switches the main power 51 to the auxiliary power 53 before the main power 51 is cut off due to fire such that the auxiliary power 53 can supply power.

If power is not normally supplied due to malfunction of the auxiliary power 53 although the main power 51 has been switched to the auxiliary power 53, the controller 20 may switch the auxiliary power 53 to the main power 51 to supply power. Accordingly, power can be supplied until the main power 51 is cut off due to fire.

That is, when the auxiliary power 53 cannot normally supply power, the main power 51 can supply power until it is cut off due to fire.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

The present invention can notify not only of a fire but also of a detected fire element for each type through analysis of a detected fire element for each type to secure reliability of fire supervision and warning.

In addition, the present invention can rapidly cope with accidents through prompt audio guidance in case of fire to secure a time for escape.

Furthermore, the present invention can improve the functionality of the fire detector even though power is not supplied through an auxiliary power.

It will be appreciated by persons skilled in the art that the effects of the present invention are not limited to what has been described above and other advantages of the invention will be more clearly understood from the following description.

What is claimed is:

1. A smart fire detector comprising:
a sensing unit configured to detect one or more fire elements;
a controller configured to analyze sensing signals detected by the sensing unit to determine whether a fire has occurred and to output a fire signal upon determining one or more of the fire elements to be relevant to a fire occurrence;
an imaging unit configured to take an image of an area in which the fire elements are detected according to the fire signal and to extract an image and a picture of a high-definition snapshot from the taken image; and
a notification unit configured to output a fire alarm and near fire escape route guidance sound according to the fire signal,
wherein the fire elements include at least one of heat, smoke, gases, and particulate matter, and the controller includes a communication unit configured to transmit the image and the picture of the high-definition snapshot extracted through the imaging unit to a control center, and a determination unit configured to compare measurement values of the fire elements detected by the sensing unit with preset reference values and analyze comparison results,
wherein the determination unit determines that a fire has occurred if the measurement values of the fire elements exceed the preset reference values.

2. The smart fire detector according to claim 1, comprising a plurality of the sensing units, and a plurality of interface units connected to the plurality of the sensing units and configured to transmit sensing signals of the plurality of sensing unit s to the controller,
wherein the plurality of the interface units are disposed in different directions such that the plurality of the sensing units connected to the plurality of interface units are disposed in different directions.

3. The smart fire detector according to claim 2, wherein the controller drives the imaging unit such that the imaging unit faces a sensing unit outputting a sensing signal corresponding to the fire signal among the plurality of the sensing units and takes an image of the area in which the fire elements have been detected.

4. The smart fire detector according to claim 3, wherein the controller derives recognition parameters of a flame image by processing images and pictures of snapshots taken in the past through machine learning, and applies the recognition parameters to the image of the area in which the fire elements are detected.

5. The smart fire detector according to claim 1, comprising a power unit for operation of the sensing unit, the controller, the imaging unit, and the notification unit,
wherein the power unit includes a main power for normally supplying power and an auxiliary power for supplying power in case of fire,
wherein power is supplied from the auxiliary power before the main power is cut off due to fire when the controller outputs the fire signal.

6. The smart fire detector according to claim 5, wherein power is supplied from the main power until the main power is cut off when the auxiliary power is not able to normally supply power.
